(19) United States
(12) Patent Application Publication
(10) Pub. No.: US 2006/0177106 A1
(43) Pub. Date: Aug. 10, 2006

(54) Database employing biometric indexing and method therefor

(75) Inventor: Peter Wrage, Ottawa (CA)

Correspondence Address: FREEDMAN & ASSOCIATES, 117 CENTREPOINTE DRIVE, SUITE 350, NEPEAN, ONTARIO, K2G 5X3, CA

(73) Assignee: Liska Biometry Inc., Dover, NH (US)

(21) Appl. No.: 11/050,727

(22) Filed: Feb. 7, 2005

(51) Int. Cl. G06K 9/00

(52) U.S. Cl. 382/115; 382/124

(57) ABSTRACT

Disclosed is a method of indexing a first database of records. A fingerprint is received and a biometric identification number is determined based thereon. A database is formed and is indexed based on the biometric identification number. As such, absent knowledge of the actual index value, the index is reconstructable based on a provided fingerprint data.

### FIELD OF THE INVENTION

The invention relates to identification systems and methods and more particularly to biometric information storage and retrieval systems and methods.

### BACKGROUND

Computer security is an important issue in society today. With the proliferation of computers and computer networks into all aspects of business and daily life—financial, medical, education, government, and communications—the concern over secure file access is growing. Using passwords is a common method of providing security. Password protection and/or combination type locks are employed for computer network security, automatic teller machines, telephone banking, calling cards, telephone answering services, houses, and safes. These systems generally require the knowledge of an entry code that has been selected by a user or has been preset.

Preset codes are often forgotten as users have no reliable method of remembering them. Writing down the codes and storing them in close proximity to an access control device (i.e. the combination lock) results in a secure access control system with a very insecure code. Alternatively, the nuisance of trying several code variations renders the access control system more of a problem than a solution.

Password systems are known to suffer from other disadvantages. Usually, a user specifies passwords. Most users, being unsophisticated users of security systems, choose passwords that are relatively insecure. As such, many password systems are easily accessed through a simple trial and error process.

A security access system that provides substantially secure access and does not require a password or access code is a biometric identification system. A biometric identification system accepts unique biometric information from a user and identifies the user by matching the information against information belonging to registered users of the system. One such biometric identification system is a fingerprint recognition system.

In a fingerprint input transducer or sensor, the finger under investigation is usually pressed against a flat surface, such as a side of a glass plate; the ridge and valley pattern of the finger tip is sensed by a sensor such as an interrogating light beam. Alternatively, thermal sensors and integrated contact sensors relying on capacitance are known.

Another use of security is for personal identification. This is used frequently in personal security applications such as building access, bank account access, international travel, and so forth. In the present international atmosphere, effective and universal methods for personal identification are preferable. With more effective methods, it is easier to track and identify undesirable individuals trying to cross international borders. This involves accurate identification of individuals as well as methodologies for cross checking between different and diverse information databases.

Most databases relating to undesirable and criminal activity include fingerprint data. Though this is true, there is presently no convenient method for searching the entire fingerprint space to match records and thereby associate individuals with diverse records, when present.

In common use, a problem in fingerprint processing relates to data retrieval. Typically, fingerprint registration data is stored within a card and within a server. In order to retrieve the information, an access key is required to uniquely identify the information. For example, a user provides a user ID and a PIN to a system prior to providing a live scan of a finger tip in order to gain access based on fingerprint identification. This overcomes drawbacks associated with one to many fingerprint identification techniques. Unfortunately, this results in significant inconvenience.

Firstly, systems supporting user data entry such as ATM machines are subject to significant vandalism. As such, most are monitored for security reasons. Vandalism resulting in damage to a data access panel renders the panel useless and often results in an unusable secure entry mechanism.

Secondly, as databases of fingerprints and personal information grow in size, unique user IDs become more complex and, therefore, harder to remember. One approach to overcoming this concern is to equip users with identification cards that provide the index number information upon being presented to a card reading system. For example, such a card comprises a smart card. Alternatively, the card comprises a magnetic stripe encoded with the index number. Advantageously, such a card is portable and the index number is typically not very large. For example, using sequential numbering, a unique index number for a record for each member of the entire planet's population can be encoded with fewer than 20 Bytes.

Unfortunately, absent the card, the user cannot access the secure system or the secured process. Further, it is difficult, if not impossible, to retrieve the user's data record without substantial inconvenience.

It would be advantageous to provide a method and apparatus for encoding, in a numeric identifier, fingerprint and other identifying information for use in user authentication and in indexing of a database.

### SUMMARY

In accordance with an aspect of the invention there is provided a method of indexing a first database of records comprising: receiving biometric information of an individual; processing the biometric information of the individual to determine an biometric identifier number, the biometric identifier number derived from the biometric information; receiving personal data relating to the individual; storing within at least a first field within a record the personal data and within at least a second field within the record the biometric identifier number; and, indexing the records within the database based on data within the at least a second field.

In accordance with another aspect of the invention there is provided a system comprising: a biometric transducer for receiving biometric information of an individual; and, a processor for processing the biometric information of the individual to determine an biometric identifier number, the number derived from the biometric information, for receiving personal data relating of the individual, for storing within at least a first field within a record of a first database the data and within at least a second field within the record of the first database the biometric identifier number and, for indexing the records within the first database based on data within the at least a second field.

In accordance with another aspect of the invention there is provided a data record comprising: a plurality of data fields; and an index field for use in indexing of a plurality of data records having index data stored therein, the index data, approximately stably derived from at least one live fingerprint of a same finger tip of an individual.

In accordance with another aspect of the invention there is provided a method of indexing a first database of records comprising: receiving biometric information of an individual; obtaining a biometric identification number that is based upon same biometric information of the individual; retrieving a record from an indexed database of records, using an index based on the biometric identification number; and, authenticating the individual based upon a comparison of the received biometric information and biometric template information stored within the indexed database.

In accordance with an embodiment obtaining comprises determining the biometric identification number that is based upon same biometric information of the individual.

In accordance with an embodiment obtaining comprises reading the biometric identification number from a portable storage medium.

### BRIEF DESCRIPTION OF THE DRAWINGS

FIG. 1 shows a schematic representation of a prior art database for use in biometric authentication;

FIG. 2 shows a simplified flow diagram of a method for authenticating a user based upon a record stored within the prior art database of FIG. 1;

FIG. 3 shows a simplified flow diagram of a method for authenticating a user by using a User ID to index records stored within the prior art database of FIG. 1;

FIG. 4 shows a simplified flow diagram of a method of generating an identification card in the form of a contact-less Smart ID card that meets FIB 201 standards;

FIG. 5 shows a simplified flow diagram of a method of cross correlating between different databases in order to identify same individuals within more than one database;

FIG. 6 shows a simplified flow diagram of a method of generating a biometric identification number;

FIG. 7 shows a simplified flow diagram of a method of generating an extended biometric identification number;

FIG. 8 shows a sample extended biometric identification number encoded as a barcode;

FIG. 9 shows a simplified flow diagram of a method of indexing a database of records; and,

FIG. 10 shows a simplified flow diagram of another method of indexing a database of records.

### DETAILED DESCRIPTION OF EMBODIMENTS OF THE INVENTION

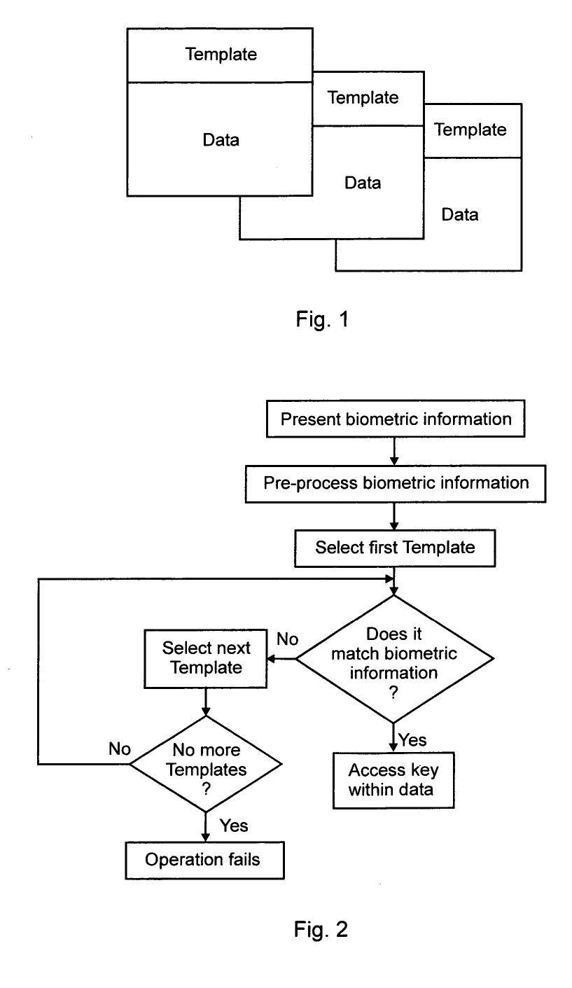

Referring to FIG. 1, shown is a prior art database for use in biometric authentication. Here, a plurality of records is shown, each having a separate template, for instance, a fingerprint template, for use in matching of biometric information captured for user authentication. Within each record is stored user identifier information including a name, and security related information such as a decryption key.

In use, as shown in the flow diagram of FIG. 2, a user presents biometric information to a biometric transducer, such as for instance a biometric optical scanner. The biometric information is captured and preprocessed resulting in biometric data, which is then provided to a server. On the server, the biometric data is verified against each of the templates in order to determine a record from the plurality of records corresponding to the provider of the biometric information. Once a matching record is found, the decryption key is accessible.

Unfortunately, for very large databases with very many entries, such a system is limited in applicability since it is very slow and highly susceptible to false acceptances because of the high load on server computational capability.

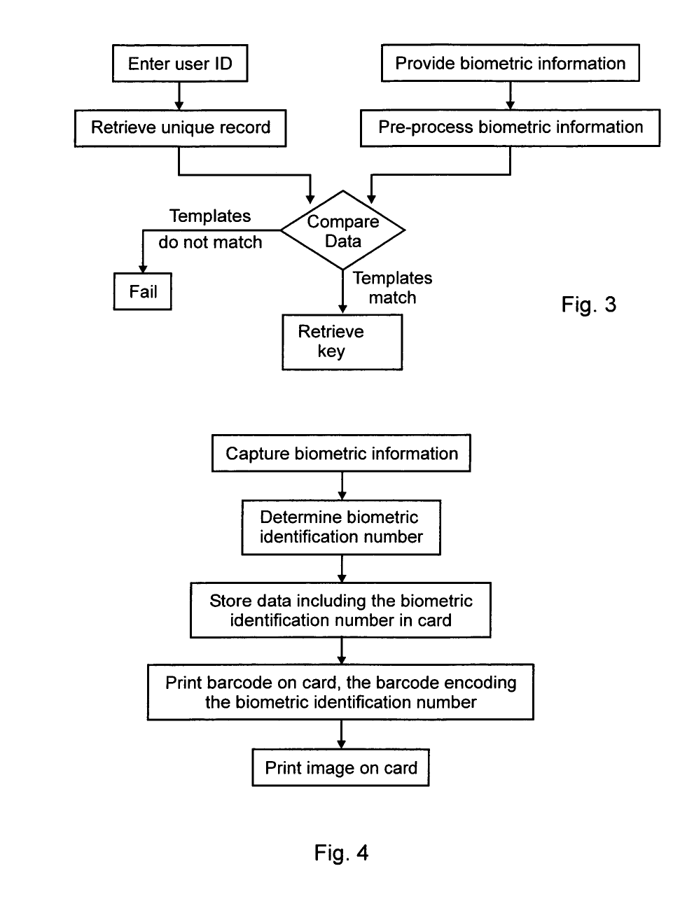

In FIG. 3, a simplified flow diagram of another prior art method is shown. Here, the database is indexed according to a User ID. As such, a user enters their User ID and the server is able to access a unique record of the user including a template stored therein. Next, the user provides biometric information that is preprocessed to result in biometric data that is then compared against registration template data within the unique record in a one-to-one fashion. When used with a password, this significantly reduces the false acceptance problem of one-to-many matching, but adds inconvenience to the operation of the system because of the resulting server load problem. Further, complex data entry devices, such as keyboards, are quite susceptible to vandalism and to tampering. As such, the method of FIG. 3 is not ideal. Further, the method of FIG. 3 is not well suited to cross referencing numerous databases in order to improve security for international travel applications.

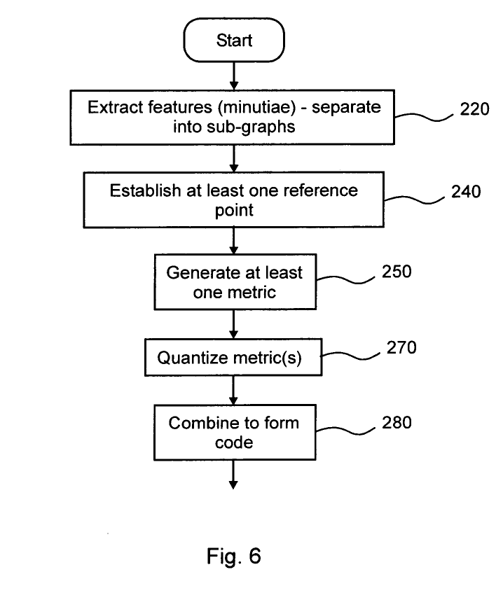

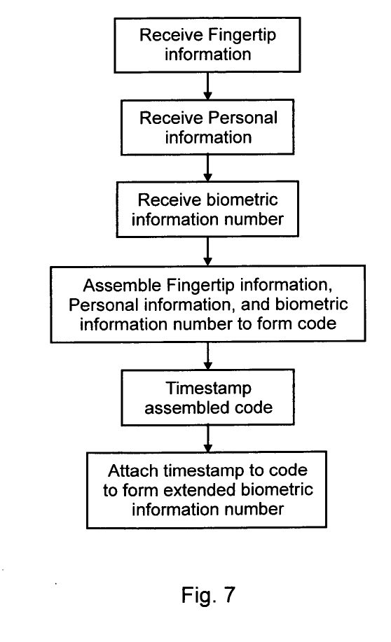

Referring to FIG. 4, a simplified flow diagram of a method of generating an identification card in the form of a contact-less Smart ID card that meets FIB 201 standards is shown. The card is printed for a visitor including a ciphered fingerprint template, and a biometric identification number is stored within memory of the card. Preferably, the biometric identification number is an extended biometric identification number including personal information. Some non-limiting examples of personal information include a name, a birth date, gender, visa registration and expiry dates, nationality, etc. Methods for generating biometric identification numbers and extended biometric identification numbers are described with reference to FIGS. 6 and 7, respectively, below. Further, the personal information preferably according to NIST standards is printed on the card along with a machine-readable code in the form of a barcode encoding the personal information and the biometric identification number. Preferably, an image of the individual's facial features that meets FIB 201 standards is also printed on the card.

The card provides for electronic transfer of personal data, e.g. a fingerprint template, for manual inspection of an individual, and includes data useful for indexing a database of personal data and related fingerprint templates stored within a server. The card is adequate for personal identification in many situations. For example, it may include all the information currently in a driver's license and, as such, be a viable replacement for that license. The additional information is useful in security related situations.

The information within the card is also stored within a record within a database. The record optionally includes other information relating to the individual. The record also preferably includes further fingerprint template information for the individual for use in cross correlation with other fingerprint template databases. The record is indexed by a number that is determinable from the fingerprint template in the form of the biometric identification number. Thus, the record is retrievable by presenting the card or by presenting a fingerprint to a data entry point.

Since the unique biometric identification number, preferably the extended biometric identification number, is included within the identification card, a record associated with an individual is instantly retrievable by presenting the card. Further, even when a card is lost, forgotten or when someone refuses to provide a card, the biometric identification number is determinable from their biometric information, and the biometric identification number is at least part of the index to the record of that individual. As such, a small search space within the database results, preferably including only one record but potentially including a set of records including more than one record. That set is then searchable relatively rapidly due to its small size and the presence within each record of fingerprint template data for comparison with the fingerprint provided.

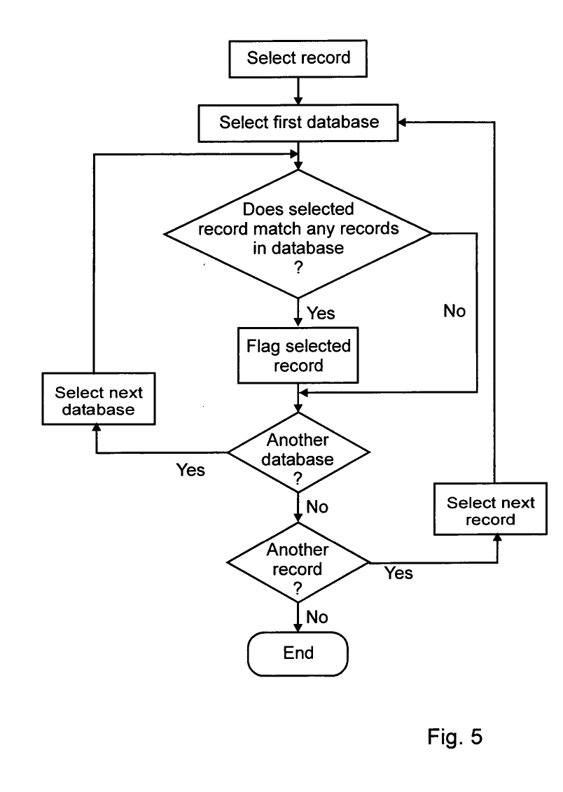

Referring to FIG. 5, shown is a simplified flow diagram of a method of cross correlating between different databases in order to identify same individuals within more than one database. A record is selected and a first database is selected. A determination is made whether the selected record (e.g. fingerprint data) matches with any of the records in the first database. If the result is yes, then the selected record is flagged. If the result is no, then a next database is selected and a new determination is made whether the selected record matches with any of the records in the next database. When no next databases remain, then a next record is selected and the determinations are repeated for the first, database, the next database, etc. When no next records remain, the process ends.

As described with reference to FIG. 5, the fingerprint data stored within each record is compared to other fingerprint data within a same database and within other databases. For each record identified as potentially problematic—whether there are reasons to detain the individual or the individual has more than one identification or some other problem—a flag is set within the record and information relating to the problem is stored therein. For example, an individual determined to be on the FBI's 10 most wanted list when identified is flagged such that passing through an airport or being pulled over results in the individual being detained. This occurs even if the individual has a different name, license, etc. as the cross correlation stores with the new license the problem that the fingerprint data is similar to that of a wanted felon.

Likewise, data within the records is usable for creating an audit trail of an individual's activities or movements. With widespread adoption, it is possible to identify and detain criminals and other undesirables when they bank, when they use credit cards, and when they are pulled over for a driving infraction. The cross correlation activity occurs in the background so that it is capable of performing highly accurate assessments of fingerprint similarity. Optionally, an operator reviews each flagged record to ensure accuracy.

Further, the cross correlation activity allows for merger of records relating to a same individual, or at least for alignment of data therein. Names are correctable—for example missing middle names are added, current addresses are updateable, and so forth. Such a system is useful in tracking various types of fraud, for instance in cases where individuals are living more than one life within a given country.

Whereas today someone can provide a false name and claim to have forgotten their ID, the system of the present embodiment allows law enforcement officers to capture fingerprint data from a suspect, retrieve their record based on the fingerprint data, and then determine if the suspect is actually wanted or not. Because of the information within each database record, a police officer has access to personal information in the form of an image of the suspect, age information, name, and so forth.

Preferably, upon accessing a flagged record, a further check of the associated database with which a problem exists is performed to see if the problem has been rectified. For example, a person may have legally changed their name. Though the records are all flagged relating to different name usage, the issue, when looked into is noted as resolved since the name changes are legal. In such a case, no negative result occurs from the flagging of the records.

The ability of the system to move the identification process computation load from the centralized database server to the system access computers, and the fact that the identification (search) process over the large database is done for only a very small percentage of the population means that the identification (search) process of a small database, such as a watch-list, can be done at the local access point computers.

Using such a multi-step biometric authentication process, e.g. with most authentication/search being done directly on the access point computer, irrelevant fingerprint templates can be excluded from a resulting search space rapidly, thereby improving performance and reducing some of the problems associated with one-to-many systems.

One method of forming a biometric identification number is described in U.S. Pat. No. 6,757,411, entitled “Method and system for fingerprint encoding and authentication,” incorporated herein by reference.

Referring to FIG. 6, a simplified flow diagram of another method of generating a biometric identification number is shown. In accordance with the method, a fingerprint is captured and pre-processed. Within the pre-processed fingerprint, minutiae are located. These minutiae are then grouped based on graph theory into sub-graphs. A reference point is then established and metrics are generated. Typically several metrics are used, though it is also possible to rely on a single metric. The metrics are quantized and then combined to form a code. Quantizing allows for a reduction in precision of each metric and allows for some variance to result in very similar metrics. The combined code is formed in such a fashion that a same fingertip imaged at different times results in an identical or near identical higher order portion of the code. In use, the lower order portion of the code may vary more than the higher order portion. That said, the code is sufficiently stable for use in indexing of personal information records.

Preferably, the biometric identification number generation system results in a number that encodes personal information, registration/expiry visa dates and biometry fingerprint template information and is not subject to tampering.

Referring now to FIG. 7, a simplified flow diagram of a method of generating an extended biometric identification number is shown. A biometric identification number is generated, for instance using the method described with reference to FIG. 6. Additional personal information is then attached to this biometric identification number, the additional information in the form of finger information, personal information including for example name, sex, birth date and nationality and a timestamp indicating date related information in the form of visa registration and expiry dates, etc. Since the biometric identification number remains stable, the resulting extended biometric identification number is encodable based thereon to prevent tampering. Alternatively, other forms of tamper protection are employed. Of course, with database access, tampering is immediately detected as the information on the card and within the database are different one from another.

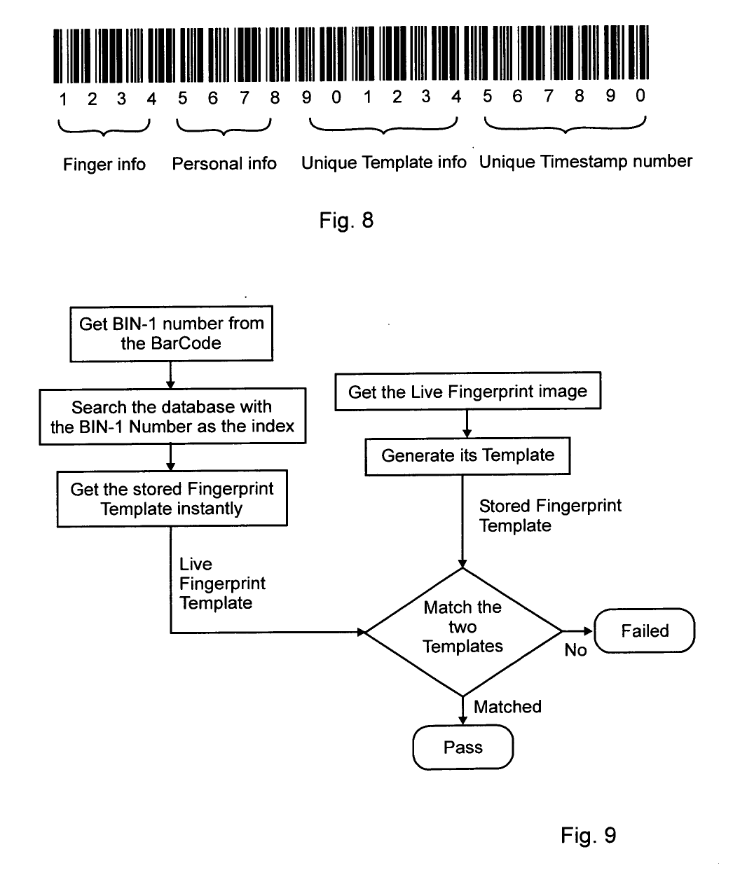

Referring to FIG. 8, a sample extended biometric identification number, encoded as a barcode, is shown. The code comprises 20 bytes and is arranged as follows: finger information is encoded within 4 bytes wherein a first byte is used for the classification of a hand and has values of 1 for the left hand and 2 for the right hand and 0 for an unknown hand. The second byte is for encoding finger information with potential values including {1: Thumb, 2: the second finger, 3: the third finger, 4: the fourth finger, 5: the fifth finger, 0: unknown finger}. Of course, the resulting selection of hands and fingers allows for 33 possibilities and is easily encodable within a single byte should there be a need to encode other information within the barcode. Within the third byte is encoded data for classification of a fingerprint. Potential values include {1: Arch, 2: Tented arch, 3: left loop, 4: right loop, 5: whorl, 6: others; 0: unknown}. The fourth byte is reserved for further data.

Personal Information is encoded within 4 bytes. The first byte is for classification based on gender. Potential values include {1: female, 2: male, 0: unknown}. The remaining three bytes are reserved and may encode data such as birthdate, nationality, name, description, and aliases.

Unique Template Information is encoded within 6 bytes. This information is generated from unique characteristics of the fingerprint template file. The unique template information is usable for verification of the finger template as a digital signature.

Unique Timestamp Identifier is encoded as 6 bytes. This value is generated from a timestamp of the enrollment process. It is used for guaranteeing a unique characteristic of the biometric identification number when used as an index. It is also useful in determining when a card has expired.

Using an extended biometric identification number allows for encoding of other information within the machine readable data on the card such that even when database access is not available, personal information and personal permissions such as license restrictions, visa information, etc. are accessible. Further, the extended biometric identification number is useful for indexing of the database in order to further ensure uniqueness of each index.

Referring to FIG. 9, a method of indexing a database of records as described hereinabove and given the card is shown. A live fingerprint is captured. The card is presented to the system. A biometric identification number (BIN-1 number) is retrieved from the card and used to index the database. For instance, the BIN-1 number encoded as a bar code is scanned using any suitable scanner. A resulting unique record is retrieved from the database and a biometric template stored therein is provided for correlation with the captured live fingerprint. Once correlated, the system performs one of identifying and authorizing the bearer of the card in dependence upon a result of the correlation. Typically, the bearer of the card is authorized or identified when the correlation is indicative of a match and is not authorized and not identified when the correlation is indicative of other than a match. Optionally, the captured live fingerprint is also compared with fingerprint template data that is stored within the card. This can be done at a point of access computer absent communication with a database. Advantageously, an initial determination can be made whether the bearer of the card is actually the person for whom the card was initially generated. Comparison of the captured live fingerprint with the biometric template stored in the database then confirms the identity of the bearer and detects any tampering with the card.

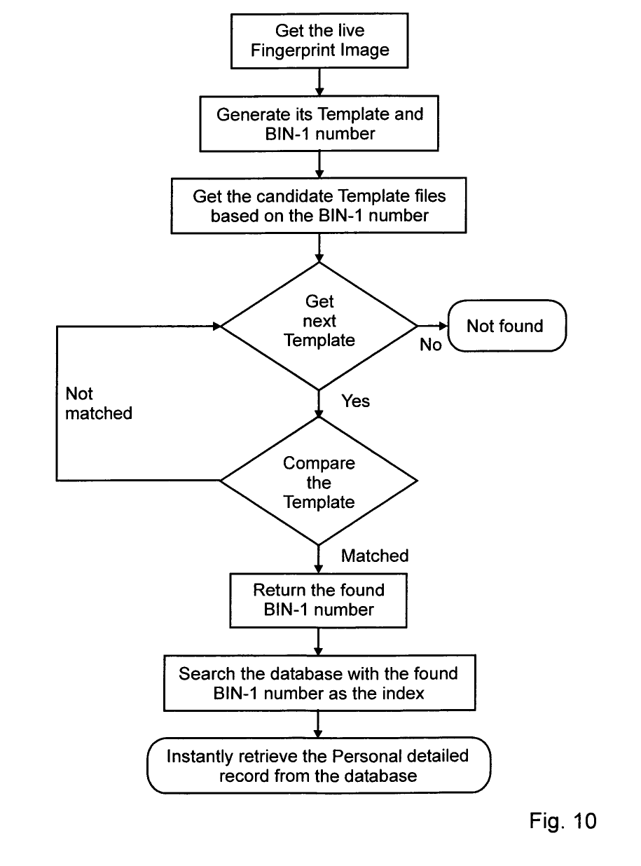

Referring now to FIG. 10, a method of indexing a database of records as described hereinabove and absent a card is shown. A live fingerprint image is captured. The fingerprint image is processed to determine a biometric identification number (BIN-1 number). Based on the determined biometric identification number, one or more biometric templates are retrieved from the database. The fingerprint image is processed to extract therefrom feature data for comparison with each biometric template retrieved in order to find a match. For each retrieved biometric template, the feature data is compared with template data stored therein to identify a match. When a match is found, an associated biometric identification number is retrieved allowing for retrieval of a unique record relating to the provided biometric information. The personal information within the retrieved unique record is then available for use in further authorizing or identifying of the individual. When no match is found among the retrieved records, the individual is not authorized and not identified. Preferably, the individual is asked to provide their biometric information again.

Though the above embodiment is described with respect to fingerprints, it is also applicable to other biometric imaging techniques such as retinal scans, facial recognition systems, pore prints, and iris scans.

Though the above embodiment includes cross correlation between diverse databases, this need not occur for the present embodiment to be advantageous. Further, the above embodiment is useful absent the personal information cards as described.

Numerous other embodiments may be envisaged without departing from the spirit or scope of the invention.

What is claimed is:

1. A method of indexing a first database of records comprising:
receiving biometric information of an individual;
processing the biometric information of the individual to determine a biometric identification number, the biometric identification number derived from the biometric information;
receiving personal data relating to the individual;
storing within at least a first field within a record the personal data and within at least a second field within the record the biometric identification number; and,
indexing the records within the database based on data within the at least a second field.

2. A method according to claim 1, wherein some of the data within a record including the biometric identification number is recorded on a portable storage medium, the biometric identification number recorded in a machine readable form.

3. A method according to claim 2, wherein the personal storage medium is an identification card.

4. A method according to claim 3, wherein the machine readable form is a barcode.

5. A method according to claim 1, wherein the biometric information comprises a fingerprint.

6. A method according to claim 5, wherein the biometric identification number is a number determined through an analysis of features within the fingerprint, the number resulting from the analysis.

7. A method according to claim 6, wherein the number is approximately a same number for a same provided fingerprint regardless of the angle of acquisition of said fingerprint.

8. A method according to claim 5, wherein the number is indicative of some features within the fingerprint, the features selected for repeatable extraction, reliability, and in such a fashion as to provide an approximately unique result.

9. A method according to claim 1, wherein at least some records of the first database include biometric data relating to biometric samples of individuals and comprising:
providing a second database comprising a plurality of records at least some records including biometric data relating to biometric samples of individuals; and,
correlating the biometric data within the first database and the biometric data within the second database to identify records pertaining to a same individual.

10. A method according to claim 9, comprising when biometric data within the first database and the biometric data within the second database pertain to a same individual, flagging a record associated with the same individual within the first database.

11. A method according to claim 1, wherein the biometric identification number is repeatably and approximately stably derived from the biometric information.

12. A method according to claim 11, wherein the biometric information comprises a fingerprint.

13. A system comprising:
a biometric transducer for receiving biometric information of an individual; and,
a processor
for processing the biometric information of the individual to determine a biometric identification number, the biometric identification number derived from the biometric information,
for receiving personal data relating of the individual,
for storing within at least a first field within a record of a first database the personal data and within at least a second field within the record of the first database the biometric identification number and,
for indexing the records within the first database based on data within the at least a second field.

14. A system according to claim 13, wherein the biometric transducer comprises a fingerprint imager.

15. A system according to claim 13, wherein the biometric identification number is determined in an approximately stable fashion.

16. A system according to claim 15, wherein the biometric transducer is a fingerprint transducer.

17. A system according to claim 16, wherein the fingerprint transducer is an optical fingerprint sensor.

18. A system according to claim 13, wherein at least some records of the first database include biometric data relating to biometric samples of individuals and comprising:
a second database comprising a plurality of records at least some records including biometric data relating to biometric samples of individuals; and wherein the processor is for correlating the biometric data within the first database and the biometric data within the second database to identify records pertaining to a same individual.

19. A system according to claim 18, wherein the biometric transducer is a fingerprint optical scanner.

20. A data record comprising:
a plurality of data fields; and
an index field for use in indexing of a plurality of data records having index data stored therein, the index data, approximately stably derived from at least one live fingerprint of a same finger tip of an individual.

21. A method of indexing a first database of records comprising:
receiving biometric information of an individual;
obtaining a biometric identification number that is based upon same biometric information of the individual;
retrieving a record from an indexed database of records, using an index based on the biometric identification number; and,
authenticating the individual based upon a comparison of the received biometric information and biometric template information stored within the indexed database.

22. A method according to claim 21, wherein obtaining comprises determining the biometric identification number that is based upon same biometric information of the individual.

23. A method according to claim 22, wherein further data within the retrieved record is used in authenticating the individual.

24. A method according to claim 22, wherein authenticating is performed on a local workstation, the local workstation other than a server hosting the database of records.

25. A method according to claim 21, comprising:
receiving personal data relating to the individual,
wherein determining the biometric identification number comprises determining an extended biometric identification number based upon same biometric information of the individual and based upon the personal data.

26. A method according to claim 22, wherein the index is the biometric identification number.

27. A method according to claim 21, wherein obtaining comprises reading the biometric identification number from a portable storage medium.

28. A method according to claim 27, comprising verifying data stored within the portable storage medium against data retrieved from the database of records.

29. A method according to claim 27, wherein authenticating is performed on a local workstation, the local workstation other than a server hosting the database of records.

30. A method according to claim 27, wherein the biometric identification number includes a signature for verifying an authenticity of the biometric identification number.

31. A method according to claim 30, wherein the signature includes time data for forming a time stamp.

32. A method according to claim 27, comprising comparing biometric template data stored within the portable storage medium with the received biometric information of the individual.

33. A method according to claim 3, comprising comparing biometric template data stored within the portable storage medium with the received biometric information of the individual.
